(19) United States
(12) Patent Application Publication
(10) Pub. No.: US 2016/0076881 A1
(43) Pub. Date: Mar. 17, 2016

(54) MEASUREMENT APPARATUS AND ADJUSTING METHOD THEREOF

(71) Applicant: CANON KABUSHIKI KAISHA, Tokyo (JP)

(72) Inventor: Naoto Hayashi, Haga-gun (JP)

(21) Appl. No.: 14/850,744

(22) Filed: Sep. 10, 2015

(30) Foreign Application Priority Data
Sep. 12, 2014 (JP) 2014-186878

(51) Int. Cl. G01B 11/25; H04N 9/31; G06T 3/40; H04N 5/225

(52) U.S. Cl. CPC G01B 11/25; H04N 5/2256; H04N 9/31; G06T 3/40

(57) ABSTRACT

A measurement apparatus for measuring an object based on an image of the object, including a projection unit including a pattern forming unit configured to form a light pattern, and a projection optical system configured to project the formed light pattern on the object, and an image pickup portion including an image pickup unit provided with a light-receiving surface and configured to receive light from the object on the light-receiving surface and pick up an image of the object, and an image-forming optical system configured to guide light from the object on which the light pattern is projected to the light-receiving surface. The image pickup unit includes an adjustment unit that makes an angle of the image-forming optical system with respect to the light-receiving surface adjustable. The adjustment unit makes a tilt angle of the image-forming optical system in a direction crossing an epipolar plane adjustable.

### BACKGROUND OF THE INVENTION

1. Field of the Invention

The present disclosure generally relates to a measurement apparatus and an adjusting method thereof.

2. Description of the Related Art

There has been a measurement apparatus of a pattern projection system that projects a light pattern on an object, picks up an image of the object, and measures a three-dimensional shape of the object based on an image pickup result.

The measurement apparatus is provided with a head including a projection unit that projects a light pattern, and an image pickup unit that picks up an image of an object. A calculation unit is provided inside or outside the measurement apparatus. An image of the object on which a known light pattern is projected from a projection lens of the projection unit is picked up by a sensor through an image pickup lens of an image pickup unit. The calculation unit performs calculation based on triangulation using the image pickup result, and obtains a distance to the object, and the shape of the object.

Mechanism tolerance, and image distortion caused by the optical system occur in the image pickup unit and the projection unit used in the measurement apparatus, which produce measurement errors. Therefore, measurement accuracy is improved by acquiring a calibration value for calibrating a measurement result by measuring a known reference, and correcting the measurement result so as to remove the measurement error resulting from the mechanism and optical system (Japanese Patent Laid-Open No. 2008-170280).

Japanese Patent Laid-Open No. 2008-170280 discloses the following: a calibration chart as a reference is measured while changing a distance from a projection unit. In a state in which a relative angle between an optical axis of the image pickup lens and a sensor is inclined from a vertical angle, defocusing distribution of an image occurs on a sensor plane. Image distortion depending on the distance from the projection unit changes due to the combination that defocusing distribution changes depending on the distance to the calibration chart, and aberration of image pickup lens.

Data of image distortion depending on the distance from the projection unit is measured by measuring a calibration chart, while changing the distance from the projection unit, the data is stored as calibration data and the image data is calibrated using the calibration data.

It has been found out that image distortion depending on distance is caused by inclination of an image pickup lens in a direction crossing an epipolar plane during triangulation to cause inclination of an angle between a sensor plane and an optical axis of the image pickup lens from a vertical angle. Similarly, a tilt angle of a projection lens and a light pattern forming unit also causes distortion of a light pattern to be projected.

Japanese Patent Laid-Open No. 2008-170280 does not describe the tilt angle, and does not adjust the image pickup unit in consideration of the tilt angle. In the method of Japanese Patent Laid-Open No. 2008-170280, if calibration data quantity is large, calculation for calibration in actual shape measurement takes time.

### SUMMARY OF THE INVENTION

According to an aspect of the present disclosure, a measurement apparatus for measuring an object based on an image of the object, includes a projection unit including a pattern forming unit configured to form a light pattern, and a projection optical system configured to project the formed light pattern on the object; and an image pickup unit including an image pickup portion provided with a light-receiving surface and configured to receive light from the object on the light-receiving surface and pick up an image of the object, and an image-forming optical system configured to guide light from the object on which the light pattern is projected to the light-receiving surface, wherein the image pickup unit includes an adjustment unit that makes an angle of the image-forming optical system with respect to the light-receiving surface adjustable, and the adjustment unit makes a tilt angle of the image-forming optical system in a direction crossing an epipolar plane defined by the projection unit and the image pickup unit adjustable.

Further features of the present disclosure will become apparent from the following description of exemplary embodiments with reference to the attached drawings.

### BRIEF DESCRIPTION OF THE DRAWINGS

FIGS. 1A and 1B illustrate a measurement apparatus of a first embodiment.

FIGS. 2A and 2B illustrate an adjustment unit of the first embodiment.

FIG. 3 illustrates a shim of the first embodiment.

FIG. 4 illustrates measurement of a tilt angle of Example 1.

FIG. 5 illustrates a thickness of the shim to insert of Example 1.

FIG. 6 illustrates measurement of a tilt angle of Example 2.

FIG. 7 illustrates measurement of a tilt angle of Example 3.

FIG. 8 illustrates a chart of Example 3.

FIG. 9 illustrates an adjustment unit of the second embodiment.

FIG. 10 illustrates an adjustment unit of the third embodiment.

FIG. 11 illustrates measurement of a tilt angle of the third embodiment.

FIG. 12 is a flowchart of an adjusting method of Example 1.

FIG. 13 is a flowchart of an adjusting method of Example 3.

### DESCRIPTION OF THE EMBODIMENTS

Hereinafter, preferred embodiments of the present disclosure will be described in detail with reference to the attached drawings.

### First Embodiment

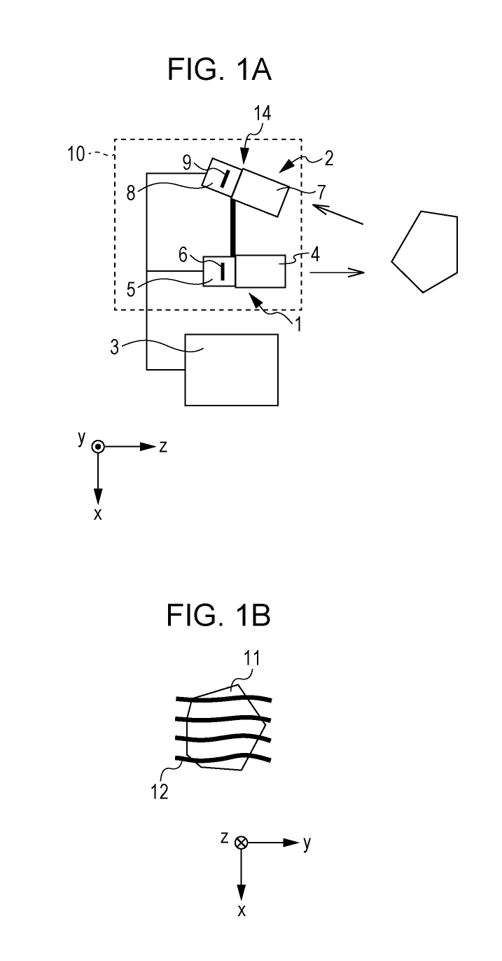

A measurement apparatus of the present embodiment is described with reference to FIGS. 1A and 1B. FIG. 1A is a schematic diagram of the measurement apparatus. FIG. 1B illustrates an object 11 on which a light pattern 12 is projected. The measurement apparatus of the present embodiment includes a head 10 (illustrated by a dashed line) and a calculation unit (a calculating portion) 3. The head 10 includes two optical units. A first optical unit is a projection unit 1 that projects a predetermined known light pattern (light intensity distribution) 12 on an object 11. A second optical unit is an image pickup unit 2 that picks up an image of the object 11 on which the light pattern 12 is projected. As used herein, the term “unit” generally refers to any combination of software, firmware, hardware, or other component, such as circuitry, that is used to effectuate a purpose.

The projection unit 1 includes a projection pattern setting element (a pattern forming unit) 6, a housing 5, and a projection optical system 4. The projection unit 1 applies light, emitted from a light source, to a projection pattern setting element 6 that forms the light pattern, and projects a pattern set in a measurement space by the projection optical system 4. In the present embodiment, as illustrated in FIG. 1B, a linear light pattern of which line (luminance) extends in the y direction is projected on the object 11. The projection pattern setting element 6 is formed by, for example, a liquid crystal element and a digital mirror device (DMD), and is capable of setting an arbitrary light pattern. Instead of the element 6 that forms variable light patterns, a glass plate in which a fixed pattern is drawn and which forms a fixed light pattern may be used. FIG. 1 illustrates a light pattern with a straight line group extending in the y direction.

The image pickup unit 2 includes a sensor element 9 (a photoelectric conversion element, such as a CMOS and a CCD) having a light-receiving surface, an image pickup lens (an image-forming optical system) 7 that guides light from the object to the light-receiving surface, and a sensor housing 8. The sensor element 9 functions as an image pickup portion that receives light from the object on the light-receiving surface and acquires an image of the object.

Next, a measurement method using the measurement apparatus is described. The light pattern 12 consists of white and black binary stripes. While the projection unit 1 projects a plurality of kinds of light patterns, the image pickup unit 2 picks up an image for each pattern, and a signal (i.e., data) of the picked up image is stored in the calculation unit 3. The measurement space is divided based on the set value of the stripes and data of the image pickup result for each set value. Then a pixel position of the projection pattern setting element 6 of the projection unit 1 and a pixel position of the sensor element 9 of the image pickup unit 7 are correlated to an object point on a surface of the object 11 in the measurement space. Since the relationship in the position and the posture between the projection unit 1 and the image pickup unit 2 is known in advance, a distance (a position) of point on the surface of the object 11 is calculated by the calculation unit 3 in accordance with the triangulation. This process is carried out for a plurality of points on the surface of the object 11 on which the pattern is projected, whereby the shape of the object 11 is obtained. Here, the pattern is set with white and black binary stripes, but multi-values a plurality of colors may also be used.

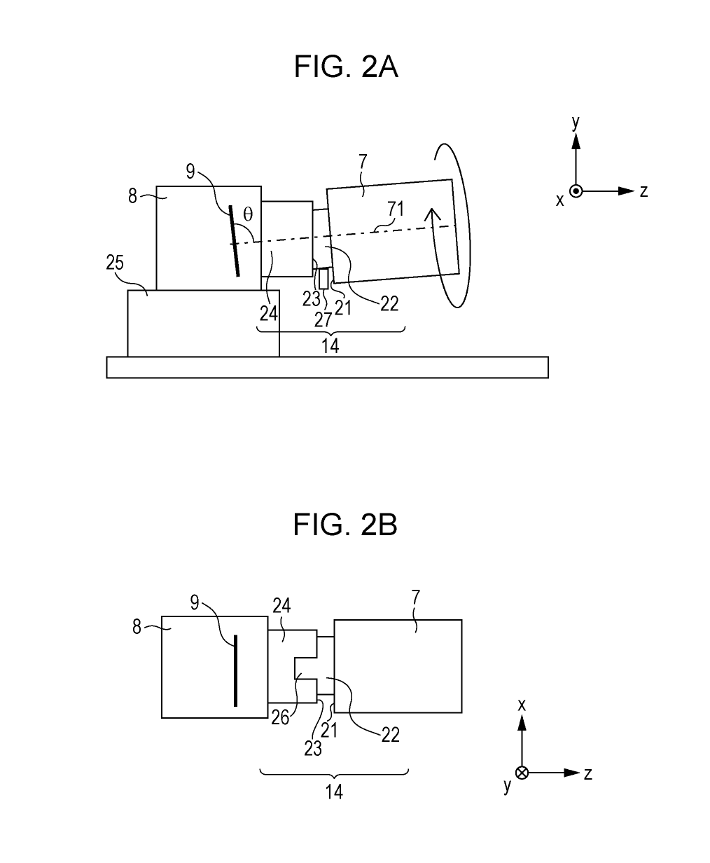

Details of the image pickup unit 2 are illustrated in FIGS. 2A and 2B. The image pickup unit 2 includes an adjustment unit 14 between the sensor housing 8 and the image pickup lens 7. In the image pickup unit 2, the image pickup lens 7 is fixed by a screwed type mount, such as a C-mount. The adjustment unit 14 includes a male screw 22, a female screw 24, a lens side fixing surface 21, a sensor side fixing surface 23, a positioning portion (a recessed portion) 26, and a shim (an adjusting member) 27. The adjustment unit 14 makes an angle θ of an optical axis 71 of the image pickup lens 7 with respect to the light-receiving surface of the sensor element 9 adjustable. In a mount in which the male screw 22 is formed on the image pickup lens 7 side and the female screw 24 (an inner portion) is formed on the sensor housing 8 side, the image pickup lens 7 is rotated as illustrated by the arrow along a screw groove until the lens side fixing surface 21 contacts the sensor side fixing surface 23. The image pickup lens 7 is thus fixed.

As magnification of lenses becomes higher due to an influence of size reduction in measurement apparatuses, required precision of the relative angle between the sensor element 9 and the sensor side fixing surface 23 becomes higher and higher and, at the same time, cost reduction is required. This causes a manufacturing error that produces a sensor tilted out of required precision. In that case, if the lens side fixing surface 21 and the sensor side fixing surface 23 are made to abut each other in their entire circumferences and fixed to each other with nothing inserted therebetween, the optical axis of the image pickup lens 7 and the light-receiving surface of the sensor element 9 are tilted from the vertical angle.

In the image pickup unit 2 of the present embodiment, it is possible to provide a larger gap than a thickness of a shim previously prepared at a part of the circumferential direction of the optical axis between the lens side fixing surface 21 and the sensor side fixing surface 23. Specifically, an inner diameter and a root diameter of the female screw 24 with respect to a root diameter and outer diameter of the male screw 22 of mount so that the image pickup lens 7 may be fixed in a tilted manner even if a shim of the maximum thickness is inserted. The maximum thickness of the shim to prepare can be estimated from the manufacturing error of the relative angle between the sensor element 9 and the sensor side fixing surface 23. A space larger than the shim 27 is provided where the shim 27 is able to be inserted. Thus a sensor stand 25 and the like does not interfere with the shim 27 near a positioning portion 26 of the sensor side fixing surface 23.

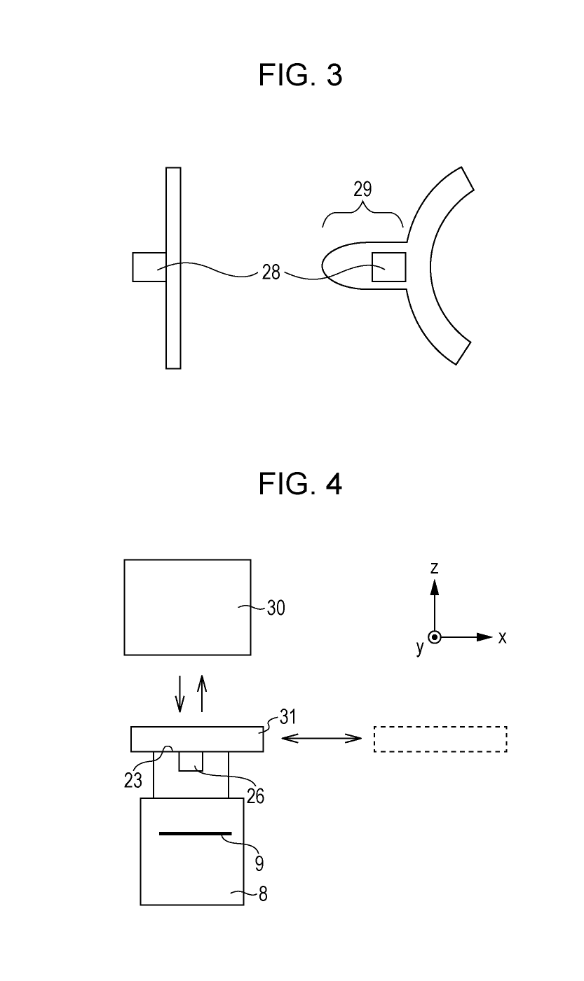

The shim 27 is illustrated in FIG. 3. The shim 27 is a Y-shaped member consisting of an arc of a circle corresponding to an outer diameter of the male screw 22 of the image pickup lens 7 and a handle 29 attached to the arc. A step (a projecting portion) 28 for the alignment with the positioning portion 26 of the sensor side fixing surface 23 is provided.

The shim 27 is inserted in a gap between the lens side fixing surface 21 and the sensor side fixing surface 23 with the shim 27 aligned with the positioning portion 26, the image pickup lens 7 (i.e., the male screw) is rotated, and the lens side fixing surface 21 and the sensor side fixing surface 23 are partially brought into contact, whereby the image pickup lens 7 is fixed. Since the lens side fixing surface 21 and the sensor side fixing surface 23 are fixed in a tilted manner, the angle θ between the optical axis of the image pickup lens 7 and the light-receiving surface of the sensor element 9 may be adjustable to a predetermined angle. The positioning portion 26 of the sensor side fixing surface 23 is provided in the direction (e.g., the vertical direction) to cross a certain epipolar plane with respect to the optical axis of the image pickup lens 7. Therefore, the adjustment unit 14 makes the tilt angle of the image pickup lens 7 in a direction to cross the epipolar plane defined by the projection unit 1 and the image pickup unit 2 adjustable and may attach the image pickup lens 7 at a predetermined angle. Here, the epipolar plane is a plane including the object side principal point of the projection lens 4, the image side principal point of the image pickup lens 7, and the object point. Since the object has a certain magnitude, the epipolar plane may be defined about one object point of the object. The epipolar plane is parallel to an xz plane of FIGS. 1A and 1B about a certain object point, and is tilted from a plane from the xz plane (i.e., a substantial xz plane) about the object point shifted to the y direction. If the lines of the light pattern 12 extend in the y direction, when the image pickup lens 7 is tilted in the y direction, distortion caused by defocusing may occur and the image may be distorted in the x direction. Since the measurement error is more sensitive to the image in the x direction vertical to the lines than in the y direction in which the lines extend, it is desirable to adjust the tilt angle of the image pickup lens 7 in the y direction. The y direction is vertical to the epipolar plane, if the epipolar plane is parallel to the xz plane. If the direction in which the lines of the light pattern 12 extend is tilted from the y direction, it is desirable to adjust the tilt angle of the image pickup lens 7 in the direction corresponding to the direction in which the lines extend. In a description different from the epipolar plane, the adjustment unit 14 makes an angle between a plane including the optical axis of the image pickup lens 7 and the object side principal point of the projection lens 4, and the light-receiving surface of the sensor element 9 adjustable.

Although not illustrated in FIG. 2B, the same positioning portion may be provided on the opposite side of the sensor side fixing surface 23, in which a shim may be inserted. Although the positioning portion 26 and the step 28 are provided to align the adjustment direction, the position may be aligned visually by, for example, drawing marking lines, or may be aligned using the handle 29 as a mark.

According to the present embodiment, the measurement error may be reduced by adjusting the image pickup unit so as to reduce image distortion. The adjustment unit has a simple configuration in which the shim is simply inserted and fixed. The adjustment unit has a single-axis configuration in the adjustment direction, which is simpler than a multi-axis configuration.

### Example 1

Next, an adjusting method of the measurement apparatus is described.

In the present embodiment, an angle between the light-receiving surface of the sensor element 9 and the sensor side fixing surface 23 (the image pickup portion side) is measured by an autocollimator 30 (S101). As illustrated in FIG. 4, a transparent parallel planar substrate 31 is disposed directly on the sensor side fixing surface 23, and aligned so that light of the autocollimator 30 is reflected on the sensor element 9 and on front and back surfaces of the substrate 31, whereby light spots can be observed by the autocollimator 30. A degree of parallelization of the substrate 31 desirably equals to the resolution of the autocollimator 30 or lower because it is convenient that the angle of light reciprocating through the substrate does not change, and that the number of reflected light from the substrate 31 is one. Therefore, the angle of the substrate 31 may be treated as an angle of the sensor side fixing surface 23.

Since a cover glass (not illustrated) exists generally before the sensor element 9, the reflected light spots of the substrate 31 and the sensor element 9 are extracted from three reflected light spots of the substrate 31, the sensor element 9, and cover glass. First, if no substrate 31 exists, no reflected light spot from the substrate 31 exists. Thus, the reflected light spot from the substrate 31 may be extracted based on a difference of measurement results of angles of the reflected light spots in the cases where the substrate 31 exists and where the substrate 31 does not exist. The reflected light spots from the sensor element 9 and the cover glass are described. Since light is reflected twice on the front and back surfaces of the cover glass and the light spots of the cover glass become brighter than the reflected light spots of the sensor element 9 by a wedge, the reflected light spots of the sensor element 9 may be extracted from the viewpoint of light quantity. By the method described above, the reflected light spots of the sensor element 9 and the reflected light spots of the substrate 31 at the same angle with the sensor side fixing surface 23 are extracted. The angle between the light-receiving surface of the sensor element 9 and the sensor side fixing surface 23 when the image pickup unit 2 is mounted on the head 10 is obtained based on the positions of the extracted reflected light spots. A tilt angle component with respect to the direction to cross the epipolar plane is extracted based on the angle. The extracted angle component corresponds to the tilt angle component of the image pickup lens 7 in the direction to cross the epipolar plane, or an angle component between a surface including the optical axis of the image pickup lens 7 and the object side principal point of the projection lens 4 and the light-receiving surface of the sensor element 9.

If the substrate 31 is not able to be disposed directly on the sensor side fixing surface 23 as illustrated in FIG. 4, an adapter with known relative angle between the sensor side fixing surface 23 and the substrate 31 may be used.

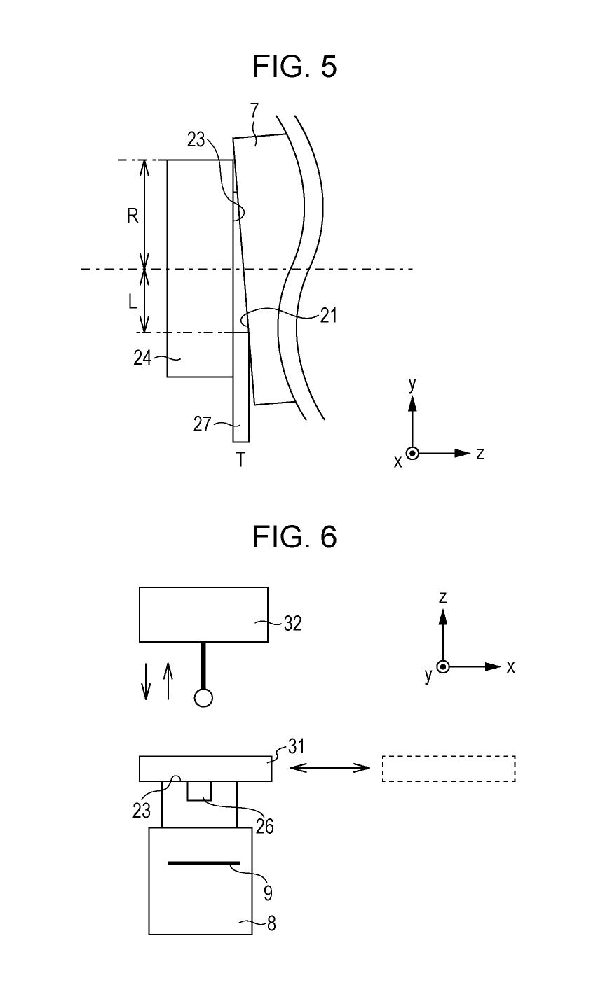

Next, based on the angle measured by the above method, an angle adjustment amount by the adjustment unit is calculated (S102). This adjustment amount is the adjustment amount of the tilt angle of the image pickup lens 7 in the direction to cross the epipolar plane, or the angle between the surface including the optical axis of the image pickup lens 7 and the object side principal point of the projection lens 4 and the light-receiving surface of the sensor element 9, and corresponds to a thickness of the shim 27. A method for calculating the thickness of the shim 27 is described with reference to FIG. 5. If a radius of the sensor side fixing surface 23 is R, a distance from the center of the mount to a point at which the shim 27 touches the lens side fixing surface 21 is L, and the above-described angle is θ, the necessary thickness T of the shim 27 is expressed by the following Expression: T=Tan θ×(R+L) (Expression 1). When the shim 27 of the thickness obtained by Expression 1 is inserted in alignment with the positioning portion 26 and the image pickup lens 7 is rotated and fixed, the light-receiving surface of the sensor element 9 and the optical axis of the image pickup lens 7 may be adjusted to be vertical to each other (S103). Although the shim 27 of the thickness obtained by Expression 1 is the most desirably used, a plurality of shims of different shim thicknesses may be prepared and a shim having a thickness close to that obtained by the Expression 1 may be selected from among the plurality of shims.

With this adjusting method, the tilt angle of the image pickup lens 7 in the direction to cross the epipolar plane, or the angle between the surface including the optical axis of the image pickup lens 7 and the object side principal point of the projection lens 4 and the light-receiving surface of the sensor element 9 may be adjusted.

### Example 2

Next, another adjusting method of the measurement apparatus is described. In this Example, the angle between the light-receiving surface of the sensor element 9 and the sensor side fixing surface 23 is measured using a three-dimensional measuring machine.

First, as illustrated in FIG. 6, a transparent parallel planar substrate 31 is disposed on the sensor side fixing surface 23, a probe of the three-dimensional measuring machine 32 is brought into contact with the surface of the substrate 31 to measure positions of a plurality of spots on the surface. The tilt angle of the substrate 31 is calculated through planar fit of a plurality of measurement values on the plane. Suppose that parallel accuracy of the substrate 31 is sufficiently higher than required accuracy, the tilt angle of the substrate 31 can be considered as an angle of the sensor side fixing surface 23.

Next, the substrate 31 is retracted from above the sensor side fixing surface 23, a probe of a three-dimensional measuring machine is made to contact with the surface of the sensor element 9 to measure the positions of the plurality of points on the surface of the sensor element 9. Then planar fit is applied to a plurality of measurement points to measure the tilt angle of the sensor element 9. A cover glass exists generally before the sensor element 9. Suppose that the angle between the cover glass and the sensor element 9 is managed, and that the relative angle therebetween is known or sufficiently small.

Based on the measured tilt angle of the sensor element 9 and the tilt angle of the sensor side fixing surface 23, a relative angle of these angles is obtained. Among the obtained relative angles, a tilt angle component with respect to the direction to cross the epipolar plane is extracted. Subsequent processes are the same as those of Example 1.

The angle of the sensor side fixing surface 23 is measured by disposing the substrate 31 in the present embodiment. Alternatively, an adapter of which angle of a surface with respect to the angle of the sensor side fixing surface 23 is managed may be used, or the sensor side fixing surface 23 may be measured directly. Instead of the three-dimensional measuring machine, a height measurement machine that measures the height using a probe moving along a single-axis direction may be used.

### Example 3

Next, another adjusting method of the measurement apparatus is described. In the present embodiment, images of a reference chart (an evaluation pattern) 13 are picked up at a plurality of distances, and an adjustment amount by the adjustment unit is calculated based on an evaluation result obtained from the images of the chart.

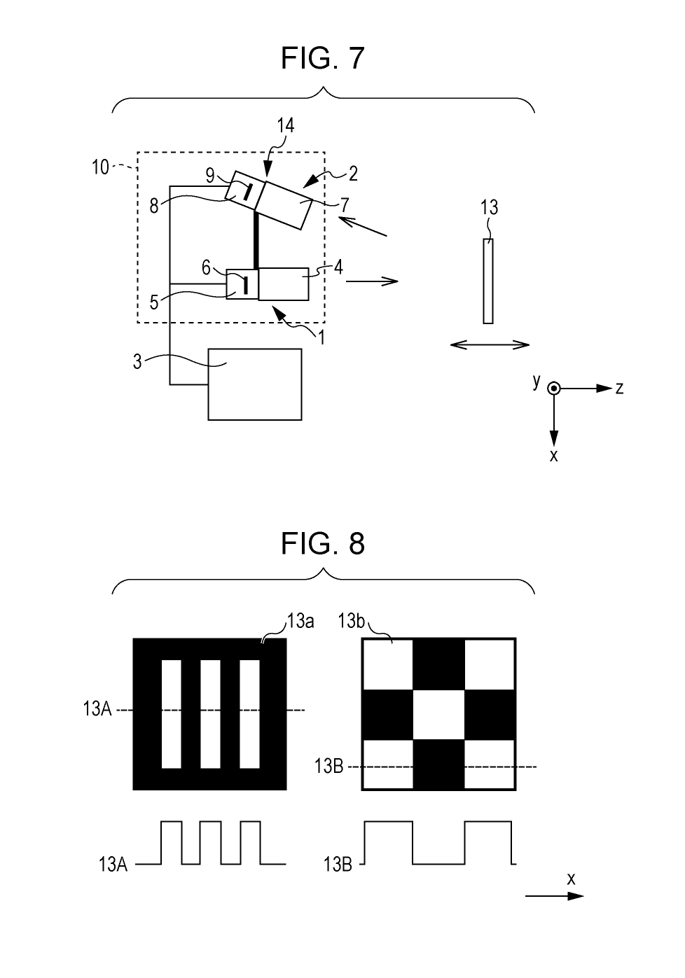

A chart 13 is installed in a measurement space as illustrated in FIG. 7. Two exemplary charts 13 are illustrated in FIG. 8. A chart 13a has arranged rectangular markers, of which central coordinates in the X direction are defined as reference center coordinates. The coordinates in the X direction are used because a measurement error is greatly influenced by the shift of the chart in the direction parallel to the epipolar plane (the X direction). A chart 13b is a checkered pattern chart to obtain both XY coordinates with cross points of the white and black square peaks as reference coordinates. Below each of the chart 13a and the chart 13b, a gradation value of light quantity in each of the cross sections 13A and 13B when images of the charts 13a and 13b are picked up is provided. When calculating the reference coordinate (i.e., rectangular marker centers and square peaks), the reference coordinate is detected by using the fact that the light volume difference at a white and black boundary portion (i.e., edge) of the cross sections 13A and 13B is large and straight-line fit and the like is applied.

Next, images of the chart 13 are picked up at a plurality of distances (in the z direction) using the measurement apparatus with no shim inserted between the lens side fixing surface 21 and the sensor side fixing surface 23 (S201). Based on the chart image at each distance, in-screen distortion of the sensor element 9 is evaluated as a characteristic of the chart image, and the in-screen distortion depending on the distance is obtained (S202). This process refers to as measurement A. The evaluation value here is the screen distortion that is the lateral shift amount of the reference coordinate. For example, the evaluation value of the chart 13a is the lateral shift amount of the center coordinates, and the evaluation value of the chart 13b is the lateral shift amount of the cross point coordinates.

Next, the image pickup lens 7 is tilted in the direction to cross the epipolar plane by a known angle amount by inserting the shim of known thickness TB between the lens side fixing surface 21 and the sensor side fixing surface 23. Then, in the same manner as in the measurement A, the images of the chart 13 are picked up at a plurality of distances, and in-screen distortion is measured from the chart 13 at each distance. This process refers to measurement B.

Based on the thickness TB of the inserted shim and the difference of the result of measurement A and the result of measurement B, a sensitivity coefficient C of the shim thickness and in-screen distortion is calculated by the following Expression: C=TB/{(distance-dependent in-screen distortion of measurement B)−(distance-dependent in-screen distortion of measurement A) (Expression 2). Since the change in the relative angle between the optical axis of the image pickup lens 7 and the light-receiving surface of the sensor element 9 is obtained from the shim thickness TB and Expression 1, the sensitivity coefficient C may be obtained as a relationship between the relative angle and in-screen distortion.

Next, using the evaluation result in measurement A, shim thickness necessary for the insertion is obtained by multiplying the sensitivity coefficient C by the distance-dependent in-screen distortion of the measurement A (S203). Alternatively, the relative angle between the optical axis of the image pickup lens 7 to be adjusted and the light-receiving surface of the sensor element 9 is obtained by Expression 1. Then the shim of obtained thickness is inserted, whereby the adjustment unit can perform adjustment (S204).

In the present embodiment, the shim of known shim thickness is inserted, distance-dependent in-screen distortion is measured, and sensitivity is obtained based on the measurement result. Alternatively, sensitivity of the evaluation value of the chart image may be obtained in advance by simulation based on the relative angle between the optical axis of the image pickup lens 7 and the light-receiving surface of sensor element 9, and lens aberration, then the adjustment amount may be calculated using the measurement result of the measurement A.

In the present embodiment, distance-dependent in-screen distortion (i.e., the lateral shift amount of the reference coordinate) is used as the evaluation value. Alternatively, the relative angle and necessary shim thickness may be obtained based on other evaluation values, such as blur quantity (i.e., a tilt amount in the black and white border (edge) in the cross sections 13A and 13B) and light quantity (height of white portion in the cross sections 13A and 13B). Alternatively, distance measurement of the chart may be carried out and the distance of the reference coordinate on each chart in a plurality of distances (a shift amount in the Z direction) may be evaluated.

### Second Embodiment

Next, a measurement apparatus of a second embodiment is described. The present embodiment differs from the first embodiment in the adjustment unit. Description is omitted about the same portions as those of the first embodiment. In the present embodiment, an adjustment mechanism (an adjusting member) 140 that adjusts tilt of the image pickup lens 7 in the direction to cross the epipolar plane is provided between the lens side fixing surface 21 of the image pickup unit 2 and the sensor side fixing surface 23. The direction to cross the epipolar plane is, for example, the direction vertical to the epipolar plane.

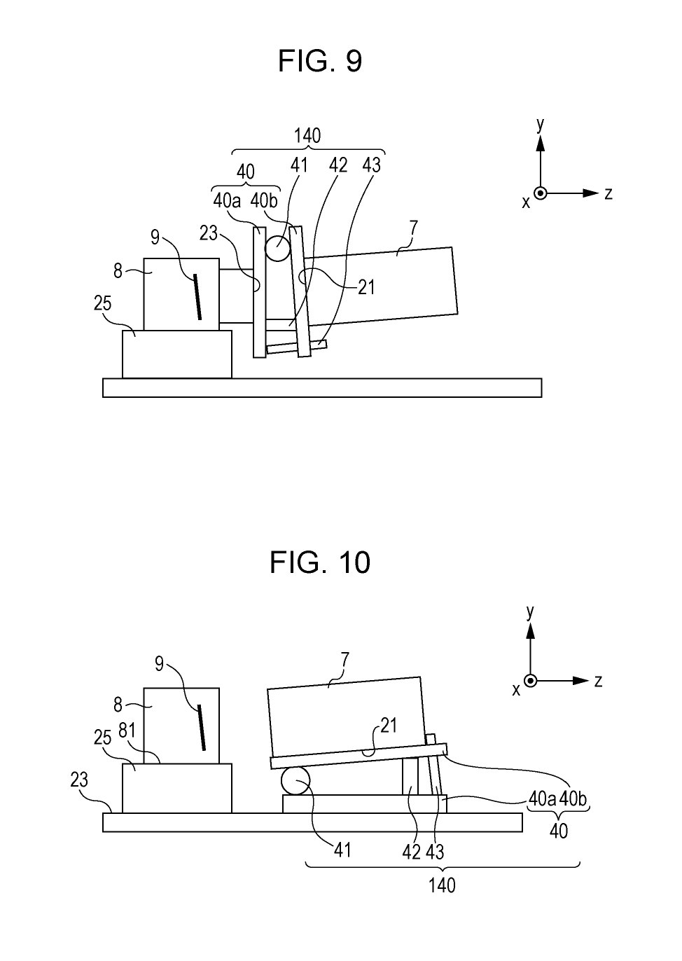

The adjustment mechanism 140 is described with reference to FIG. 9. The adjustment mechanism 140 includes plates 40, a hinge 41, a spring 42, and an adjustment screw (a movable member) 43. Each of the plates 40 (40a, 40b) is provided at the sensor side fixing surface 23 and the lens side fixing surface 21 and these plates 40 are connected by the hinge 41. The hinge 41 is mounted in a manner such that the optical axis of the image pickup lens 7 is movable in the direction to cross the epipolar plane via the plate 40b. The hinge 41 is fixed by the spring 42 with force always applied in the direction to bring the plates 40 close to each other. The relative angle between the plate 40a and the plate 40b is adjusted by a feeding amount of the adjustment screw 43. Based on the feeding amount Lc(=P×Rot) obtained from the known screw pitch P of the adjustment screw 43 and the amount of rotation Rot of the adjustment screw 43, and the distance Lh between hinge 41 and the adjustment screw 43, the angle θ to be adjusted is obtained by the following Expression: θ=ArcTan(Lc/Lh) (Expression 3).

The measurement method of the relative angle between the sensor element 9 and the optical axis of the image pickup lens 7 is the same as that of the first embodiment and is therefore not described. Based on the measured relative angle, the angle θ to be adjusted is calculated by the adjustment mechanism 140 so that the relative angle becomes a predetermined angle. Then the feeding amount Lc of the adjustment screw is obtained from the angle θ to be adjusted, and the relative angle is adjusted by rotating the adjustment screw 43 of the feeding amount.

### Third Embodiment

Next, a measurement apparatus of a third embodiment is described. The measurement apparatus of the present embodiment differs in the adjustment unit from those of the first and the second embodiments. Description is omitted about the same portions as those of the first embodiment. In the present embodiment, the adjustment mechanism 140 for adjusting tilt of the image pickup lens 7 is provided between the fixing surface 23 of the image pickup unit 2 and the image pickup lens 7.

In the present embodiment, as illustrated in FIG. 10, the sensor housing 8 and the image pickup lens 7 are separately fixed to the fixing surface 23. The fixing surface 23 is parallel to the xz plane. The lens side fixing surface 21 is disposed on the adjustment mechanism 140 side (i.e., the −Y direction side). The plates 40 (40a, 40b) are attached to the fixing surface 23 and the lens side fixing surface 21. These plates 40 are connected by the hinge 41. Here, the plate 40b attached to the lens side fixing surface 21 and the optical axis of the image pickup lens 7, and the plate 40a attached to the fixing surface 23 and a sensor housing fixing surface 81 are supposed to be sufficiently parallel to one another. The hinge 41 is attached so that the adjustment direction becomes the direction to cross the epipolar plane. Other configurations of the spring 42 and the adjustment screw 43 are the same as those of the second embodiment. The hinge 41 is fixed by the spring 42 with force always applied in the direction to bring the plates 40 close to each other. The relative angle between the sensor element 9 and the optical axis of the image pickup lens 7 is adjusted by the feeding amount using the adjustment screw 43.

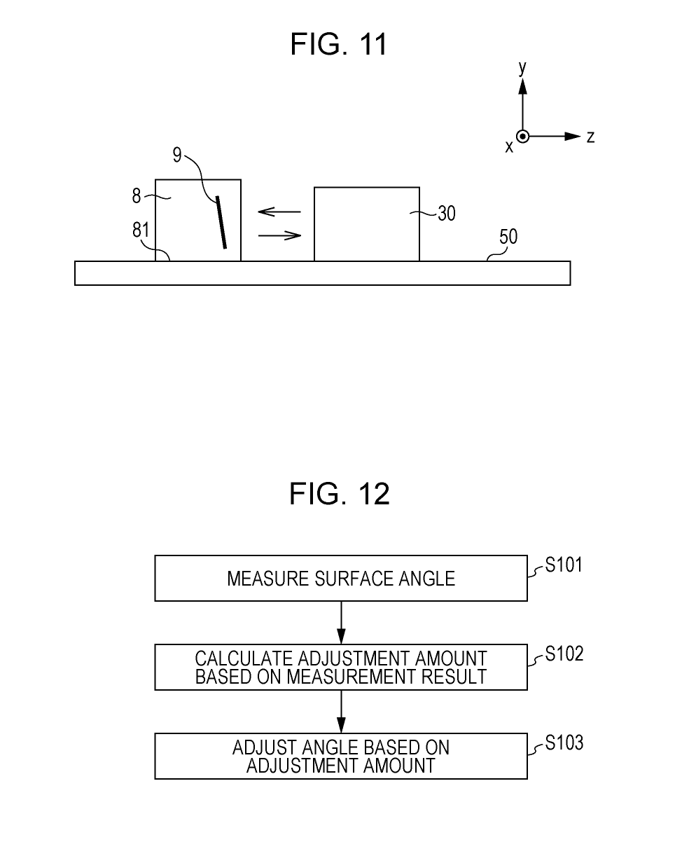

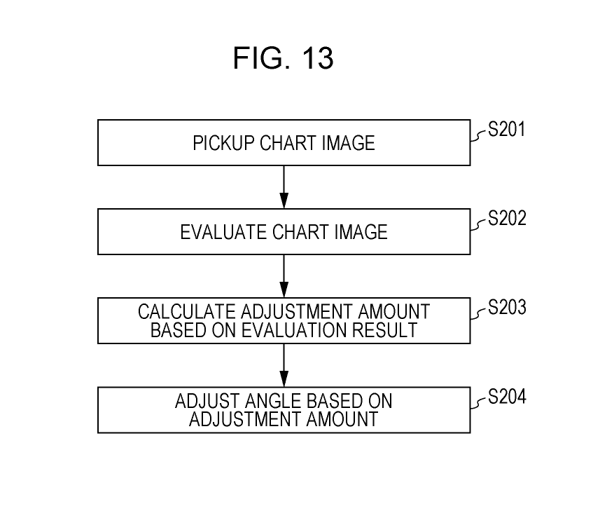

Next, the tilt angle of the sensor element 9 is measured. A relative angle of the sensor element 9 and the fixing surface 81 of the sensor housing 8 is measured. First, as illustrated in FIG. 11, the autocollimator 30 and the sensor housing 8 are disposed on a fixing surface 50 that fixes these parts. Suppose that the fixing surface 50 has enough flatness. In this state, light from the light-receiving surface of the sensor element 9 is detected by the autocollimator 30. An output of the autocollimator 30 in the angle of the ωx direction is the angle of the light-receiving surface of the sensor element 9 with respect to the fixing surface 50. This angle is the relative angle of the light-receiving surface of the sensor element 9 with respect to the fixing surface 23 when the sensor housing is mounted on the image pickup unit 2, and is the tilt angle of the light-receiving surface of the sensor element 9 with respect to the direction to cross the epipolar plane.

An amount of angle adjustment by the adjustment mechanism 140 is obtained based on the obtained tilt angle of the light-receiving surface of the sensor element 9, whereby the angle of the optical axis of the image pickup lens 7 is adjusted. The adjusting method of the adjustment mechanism 140 is the same as that of the second embodiment.

Preferred embodiments of the present disclosure have been described, but the present disclosure is not limited to the same. Various modifications and changes may be made without departing from the scope of the present disclosure.

For example, the calculation unit 3 is disposed inside the measurement apparatus in the above embodiments, but the calculation unit 3 may be disposed outside the measurement apparatus. In the embodiment, the light pattern extending in the direction vertical to the base line connecting the principal point of the projection lens and the principal point of the image pickup lens is projected. However, if a light pattern tilted from that vertical direction and extending obliquely is projected, the adjustment unit may adjust in the direction vertical to the light pattern (the periodic direction of the pattern) (i.e., in the binary pattern, the direction in which white and black edges are arranged periodically). Although the adjustment unit of the image pickup unit is described in the above embodiments, the same adjustment unit may be applied to the adjustment of the relative angle between the projection lens and the projection pattern setting element regarding the projection unit. Also in the case of the projection unit, depending on the relative angle between the projection lens and the pattern setting element, distortion of the light pattern to be projected changes depending on the distance to the object in the same manner as in the image distortion of the image pickup unit. Therefore, a length measurement error occurs if the distance is calculated based on the picked up result. It is therefore necessary to adjust the relative angle between the projection lens and the projection pattern setting element. Thus, the same adjustment unit as that of the image pickup unit may be applied to the projection unit. In the case of the projection unit, the relative angle between the fixing surface to which the projection lens is mounted and fixed, and the projection pattern setting element is measured, and the adjustment unit may adjust so that the optical axis of the projection lens is directed to an angle to cross the projection pattern setting element. The adjustment unit may adjust the tilt angle of the projection lens in the direction to cross the epipolar plane, and may adjust the angle between the surface including the optical axis of the projection lens and the image side principal point of the image pickup lens, and the light-receiving surface of the sensor.

Although two optical units in the head are the image pickup unit and the projection unit in the above embodiments, the present disclosure may be applied also to a measurement apparatus of a stereo method in which both the optical units are the image pickup units. Specifically, the measurement apparatus includes a first image pickup unit including a first image pickup portion provided with a first light-receiving surface, and configured to receive light from the object on the first light-receiving surface and pick up an image of the object, and a first image-forming optical system configured to guide light from the object to the first light-receiving surface. The measurement apparatus also includes a second image pickup unit including a second image pickup portion provided with a second light-receiving surface, and configured to receive light from the object on the second light-receiving surface and pick up an image of the object, and a second image-forming optical system configured to guide light from the object to the second light-receiving surface, In the case of this measurement apparatus, adjustment by the adjustment unit is performed to at least one image pickup unit, and the tilt angle of the image pickup lens in the direction to cross the epipolar plane passing through the image side principal point and the object point of both the image pickup lenses is made adjustable. Further, the angle between the surface including the optical axis of one image pickup lens and the image side principal point of the other image pickup lens, and the light-receiving surface of the sensor is made adjustable.

In the adjustment mechanism 140 of the second and the third embodiments, a tool with known feeding amount may be used instead of the adjustment screw. Although the adjustment mechanism adjusts the tilt of the image pickup lens, an adjustment mechanism of the tilt of the sensor housing 8 may be provided instead of or in addition to the tilt adjustment of the image pickup lens.

### Embodiment of Method for Manufacturing Article

A method for manufacturing an article in the present embodiment is used, for example, in manufacturing an article, such as a metal part and an optical element. The method for manufacturing an article of the present embodiment includes a process of measuring a shape of an object using the measurement apparatus, and a process of processing the object based on a measurement result in the measuring process. For example, the shape of the object is measured using the measurement apparatus, and the object is processed (i.e., manufactured) so that the shape of the object becomes a design value based on the measurement result. Since the shape of the object may be measured with high accuracy with the measurement apparatus, the method for manufacturing an article of the present embodiment is advantageous in at least one of performance, quality, productivity, and production cost of article as compared to the related art methods.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2014-186878, filed Sep. 12, 2014, which is hereby incorporated by reference herein in its entirety.

What is claimed is:

1. A measurement apparatus for measuring an object based on an image of the object, the measurement apparatus comprising:
a projection unit including a pattern forming unit configured to form a light pattern, and a projection optical system configured to project the formed light pattern on the object; and
an image pickup unit including an image pickup portion provided with a light-receiving surface and configured to receive light from the object on the light-receiving surface and pick up an image of the object, and an image-forming optical system configured to guide light from the object on which the light pattern is projected to the light-receiving surface, wherein
the image pickup unit includes an adjustment unit that makes an angle of the image-forming optical system with respect to the light-receiving surface adjustable, and
the adjustment unit makes a tilt angle of the image-forming optical system in a direction crossing an epipolar plane defined by the projection unit and the image pickup unit adjustable.

2. A measurement apparatus for measuring an object based on an image of the object, the measurement apparatus comprising:
a first image pickup unit including a first image pickup portion provided with a first light-receiving surface, and configured to receive light from the object on the first light-receiving surface and pick up an image of the object, and a first image-forming optical system configured to guide light from the object to the first light-receiving surface; and
a second image pickup unit including a second image pickup portion provided with a second light-receiving surface, and configured to receive light from the object on the second light-receiving surface and pick up an image of the object, and a second image-forming optical system configured to guide light from the object to the second light-receiving surface, wherein
the first image pickup unit includes an adjustment unit that makes an angle of the first image-forming optical system with respect to the first light-receiving surface adjustable, and
the adjustment unit makes a tilt angle of the first image-forming optical system in a direction crossing an epipolar plane defined by the first image pickup unit and the second image pickup unit adjustable.

3. The measurement apparatus according to claim 1, wherein
the adjustment unit includes an adjusting member configured to adjust a mounted angle of the image-forming optical system, and
the image-forming optical system is mounted at a predetermined tilt angle by the adjusting member.

4. The measurement apparatus according to claim 3, wherein
the adjusting member includes a mount configured to fix the image pickup portion and the image-forming optical system, and a shim, and
the image pickup portion and the image-forming optical system are fixed to each other with the shim inserted therebetween.

5. The measurement apparatus according to claim 4, wherein the mount includes a positioning portion configured to determine a position of the shim.

6. The measurement apparatus according to claim 3, wherein
the adjusting member includes a movable member, and
the tilt angle is changed when the movable member is moved.

7. The measurement apparatus according to claim 1, wherein the adjustment unit is disposed between the image pickup portion and the image-forming optical system.

8. The measurement apparatus according to claim 1, wherein the adjustment unit is provided between the image-forming optical system and a fixing surface of the image pickup unit.

9. The measurement apparatus according to claim 1 further comprising a calculating portion configured to calculate a shape of the object using a signal of an image from the image pickup portion.

10. A measurement apparatus for measuring an object based on an image of the object, the measurement apparatus comprising:
a projection unit including a pattern forming unit configured to form a light pattern, and a projection optical system configured to project the formed light pattern on the object;
an image pickup unit including an image pickup portion provided with a light-receiving surface and configured to receive light from the object on the light-receiving surface and pick up an image of the object, and an image-forming optical system configured to guide light from the object on which the light pattern is projected to the light-receiving surface; and
an adjustment unit configured to make an angle between a plane including an optical axis of the image-forming optical system and an object side principal point of the projection optical system, and the light-receiving surface adjustable.

11. A measurement apparatus for measuring an object based on an image of the object, the measurement apparatus comprising:
a first image pickup unit including a first image pickup portion provided with a first light-receiving surface, and configured to receive light from the object on the first light-receiving surface and pick up an image of the object, and a first image-forming optical system configured to guide light from the object to the first light-receiving surface;
a second image pickup unit including a second image pickup portion provided with a second light-receiving surface, and configured to receive light from the object on the second light-receiving surface and pick up an image of the object, and a second image-forming optical system configured to guide light from the object to the second light-receiving surface; and
an adjustment unit configured to make an angle between a plane including an optical axis of the first image-forming optical system and an image side principal point of the second image-forming optical system, and the first light-receiving surface adjustable.

12. An adjusting method of the measurement apparatus according to claim 1, the adjusting method comprising:
measuring an angle between a fixing surface on which the image-forming optical system is mounted and fixed on a side of the image pickup portion, and the light-receiving surface;
calculating, based on a measurement result in the measuring, an adjustment amount of a tilt angle of the image-forming optical system in a direction crossing an epipolar plane defined by the projection unit and the image pickup unit; and
adjusting the tilt angle based on the calculated adjustment amount.

13. The adjusting method according to claim 12 wherein, in the measuring, the angle is measured using an autocollimator by detecting reflected light from a surface of a substrate disposed on the fixing surface and the light-receiving surface, and measuring the angle between the surface of the substrate and the light-receiving surface.

14. The adjusting method according to claim 12 wherein, in the measuring, the angle is measured by measuring a shape of the surface of the substrate disposed on the fixing surface and the light-receiving surface.

15. An adjusting method of the measurement apparatus according to claim 1, the adjusting method comprising:
acquiring images of an evaluation pattern at a plurality of distances by disposing the evaluation pattern as the object, and disposing the evaluation pattern while changing the distance from the image pickup unit;
evaluating a characteristic of the acquired images;
calculating an adjustment amount of the tilt angle using a relationship between an evaluation value of the characteristic of the images of the evaluation pattern and the tilt angle of the image-forming optical system in a direction to cross the epipolar plane defined by the projection unit and the image pickup unit, and an evaluation result of the evaluation process; and
adjusting the tilt angle based on the calculated adjustment amount.

16. The adjusting method according to claim 15, wherein the characteristic of the images is distortion or blur of the images.

17. The adjusting method according to claim 15, wherein
the relationship is sensitivity of the tilt angle with respect to the evaluation value of the characteristic of the images of the evaluation pattern, and the sensitivity is obtained by simulation or measurement.

18. An adjusting method of the measurement apparatus according to claim 10, the adjusting method comprising:
measuring an angle between a fixing surface on which the image-forming optical system is mounted and fixed on a side of the image pickup portion, and the light-receiving surface;
calculating an adjustment amount of an angle between a plane including the optical axis of the image-forming optical system and the object side principal point of the projection optical system, and the light-receiving surface based on a measurement result of the measuring; and
adjusting the angle based on the calculated adjustment amount.
